(19) United States
(12) Patent Application Publication
(10) Pub. No.: US 2025/0166894 A1
(43) Pub. Date: May 22, 2025

(54) INDUCTOR DEVICES AND FORMING METHODS THEREOF

(71) Applicant: EAGLERISE INTELLIGENT DEVICE CORPORATION LTD., Foshan (CN)

(72) Inventors: Nannan Zhao, Foshan (CN); Yinglin Wang, Foshan (CN); Baoqing Ren, Foshan (CN); Fuming Liu, Foshan (CN)

(21) Appl. No.: 18/943,984

(22) Filed: Nov. 12, 2024

(30) Foreign Application Priority Data
Nov. 17, 2023 (CN) 202311542064.X

(51) Int. Cl. H01F 41/04; H01F 27/08; H01F 27/24; H01F 27/29; H01F 41/02

(52) U.S. Cl. CPC H01F 41/04; H01F 27/08; H01F 27/24; H01F 27/29; H01F 41/0206

(57) ABSTRACT

The present disclosure relates to the field of inductor, specifically to an inductor device and a forming method thereof. A coil and a magnetic core are secured through a primary injection molding process to form a primary molded body, which is then fixed with an insert to form the inductor device. Compared to current encapsulation molding process, the present application adopts a novel injection molding technique that offers higher molding efficiency. Additionally, by employing a two-stage injection molding process, the molding material can more easily penetrate into smaller gaps, ensuring more thorough filling at the corners and edges. This method also helps to reduce injection pressure, thereby decreasing the impact force on the magnetic core and lowering the risk of cracking or damage to the magnetic core.

### CROSS REFERENCE TO RELATED APPLICATIONS

The present application claims the benefit of Chinese Patent Application No. 202311542064.X filed on Nov. 17, 2023, the contents of which are incorporated herein by reference in their entirety.

### TECHNICAL FIELD

The present disclosure relates to the field of inductor devices, in particular to inductor devices and forming methods thereof.

### BACKGROUND OF THE INVENTION

High-power inductor devices for automotive use at present are typically encapsulated with thermally conductive silicone gel, which secures the inductor coil and magnetic core in place while also conducting the heat generated by them. However, the current encapsulation process for these inductor devices is relatively complex, resulting in low efficiency for forming inductor devices.

### SUMMARY OF THE INVENTION

The present disclosure provides methods for forming inductor devices, aimed at improving the current technical issue of low efficiency in inductor formation.

Additionally, one of the objectives of the present disclosure also lies in providing inductor devices.

In accordance with a first aspect of the present disclosure, a forming method for an inductor device provided in some embodiments may include:
securing a coil and a magnetic core together by means of a primary injection-molded body obtained by a primary injection molding process, so that the coil, the magnetic core and the primary injection-molded body form a primary molded body, and subsequently, fixing an insert in the inductor device and the primary molded body together by means of a secondary injection-molded body obtained by a secondary injection molding process.

Further, in some embodiments, an injection pressure for the secondary injection molding process may be greater than that for the primary injection molding process.

Further, in some embodiments, during the primary injection molding process, a lead-out fixing part may be injection-molded onto a lead-out terminal of the coil for securing the lead-out terminal in place.

Further, in some embodiments, during the secondary injection molding process, a part of the secondary injection-molded body may be injection-molded onto the lead-out fixing part for reinforcement.

Further, in some embodiments, during the primary injection molding process, the magnetic core may be contacted and positioned by a primary injection positioning mold that may form a primary process hole during the primary injection molding process; and during the secondary injection molding process, at least a secondary injection positioning mold that may form a secondary process hole during the secondary injection molding process may be inserted into the primary process hole to position the primary molded body, wherein the at least a secondary process hole may be communicated with the primary process hole to form a through-hole.

In accordance with a second aspect of the present disclosure, an inductor device provided in some embodiments may include a coil, a magnetic core, a primary injection-molded body and a secondary injection-molded body, wherein the primary injection-molded body may secure the coil and the magnetic core, and at least a part of the primary injection-molded body may be arranged in a gap between the coil and the magnetic core.

The inductor may further include an insert, and the secondary injection-molded body may be formed on the primary injection-molded body and may fix the insert in place.

Further, in some embodiments, the coil may have an exposed first heat dissipation surface, the secondary injection-molded body may have a thermal pad positioning tooth configured to press against a thermal pad attached onto the first heat dissipation surface, and, in a direction perpendicular to the first heat dissipation surface, the top surface of the thermal pad positioning tooth may be level with or lower than a plane of the first heat dissipation surface.

Further, in some embodiments, the coil may comprise a lead-out terminal, the primary injection-molded body may comprise a lead-out fixing part that is injection-molded on the lead-out terminal and may secure the lead-out terminal, a part of the secondary injection-molded body may be injection-molded on the lead-out fixing part for reinforcement.

Further, in some embodiments, the primary injection-molded body may have a primary process hole configured to allow a primary injection positioning mold to contact and position the magnetic core, wherein the coil, the magnetic core and the primary injection-molded body may together form a primary molded body; the secondary injection-molded body may have a secondary process hole configured to allow a secondary injection positioning mold to contact and position the primary molded body; and at least a secondary process hole and the primary process hole may be communicated to form a through-hole.

Further, in some embodiments, the primary injection-molded body may comprise a primary injection-molded layer covering a side of the magnetic core that faces away from the coil, and the secondary injection-molded body may comprise a secondary injection-molded layer arranged at an outer side of the primary injection-molded layer, wherein the ratio of a thickness of the secondary injection-molded layer to a thickness of the primary injection-molded layer may be greater than 1.

According to the forming method for an inductor device disclosed in the aforementioned embodiments, the coil and the magnetic core can be secured by means of a primary injection molding process to form a primary molded body, which is then fixed with an insert to form the inductor device. Compared to the current encapsulation molding process, the present application adopts a novel injection molding technique that boosts molding efficiency. Additionally, through such a two-stage injection molding process, the molded material can more easily penetrate into smaller gaps, ensuring more complete filling at the corners. It also helps to reduce injection pressure, thereby decreasing the impact force on the magnetic core and lowering the risk of cracking or damage to the magnetic core.

### BRIEF DESCRIPTION OF THE DRAWINGS

FIG. 1 is a schematic view of the structure of an inductor device in some embodiments;

FIG. 2 is a schematic view of the structure of the inductor device from another perspective in some embodiments;

FIG. 3 is a schematic view of the combined structure of an inductor device and a thermal pad in some embodiments;

FIG. 4 is a schematic view of the positions of a coil and a magnetic core in some embodiments;

FIG. 5 is a schematic view of the structure of a primary molded body in some embodiments;

FIG. 6 is a schematic view of the structure of the primary molded body from another perspective in some embodiments;

FIG. 7 is a schematic view of the structure of a secondary injection-molded body in some embodiments;

FIG. 8 is a schematic view of the structure of another inductor device in some embodiments; and

FIG. 9 is a schematic top view of the another inductor device in some embodiments.

List of feature names corresponding to the reference numerals in the accompanying figures:

| | |
|---|---|
| 1 | coil |
| 11 | lead-out terminal |
| 12 | first heat dissipation surface |
| 2 | magnetic core |
| 21 | outer circumferential surface |
| 3 | primary injection-molded body |
| 31 | lead-out fixing part |
| 32 | primary injection-molded layer |
| 33 | primary process hole |
| 4 | insert |
| 41 | fixing nut |
| 42 | terminal nut |
| 5 | primary molded body |
| 6 | secondary injection-molded body |
| 61 | thermal pad positioning tooth |
| 62 | secondary process hole |
| 63 | secondary injection-molded layer |
| 64 | fixing slot |
| 7 | conducting bar |
| 8 | through-hole |
| 9 | thermal pad |

Explanation of the reference numerals with parentheses in the accompanying drawings: In the drawings, the features indicated by the reference numerals in brackets correspond to the features represented by the number inside the brackets and those represented by the numbers outside the brackets.

### DETAILED DESCRIPTION

The present disclosure will be further detailed below through specific embodiments with reference to the accompanying drawings. Common or similar elements are referenced with like or identical reference numerals in different embodiments. Many details in the following embodiments are described to facilitate a better understanding of the present application. However, it will be effortlessly recognized by those skilled in the art that some features may be omitted under different circumstances or may be substituted by other components, materials, or methods. For clarity some operations related to the present disclosure are not shown or illustrated herein so as to prevent the core from being overwhelmed by excessive descriptions. For those skilled in the art, such operations are not necessary to be explained in detail, and they can fully understand the related operations according to the description in the specification and the general technical knowledge in the art.

Additionally, the characteristics, operations, or features described in the specification may be combined in any appropriate manner to form various embodiments. At the same time, the steps or actions in the described method can be reordered or adjusted in ways that are obvious to those skilled in the art. Therefore, the various sequences in the specification and drawings are merely for clearly describing a particular embodiment and are not intended to be an order of necessity, unless otherwise stated one of the sequences must be followed.

The serial numbers assigned to components herein, such as “first”, “second”, etc., are used solely for distinguishing the described objects and do not carry any sequential or technical meaning. The terms “connected”, “coupled” and the like here include direct and indirect connections (coupling) unless otherwise specified.

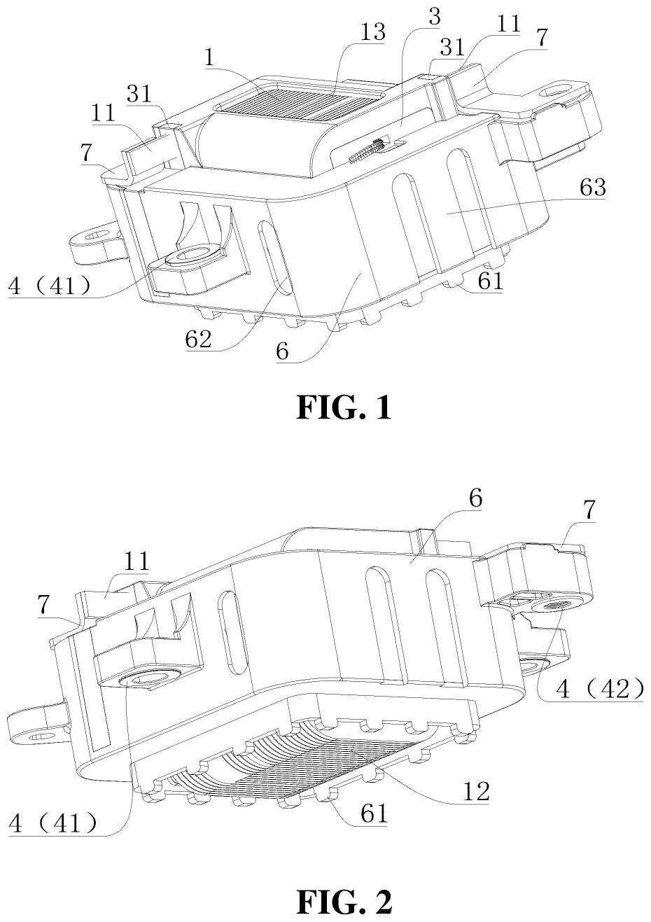

In some embodiments, as shown in FIGS. 1 to 7, a forming method for an inductor device may include:
securing a coil 1 and a magnetic core 2 together by means of a primary injection-molded body 3 obtained by a primary injection molding process so that the coil 1, the magnetic core 2 and the primary injection-molded body 3 together form a primary molded body 5, and then fixing an insert 4 in the inductor device and the primary molded body 5 together by means of a secondary injection-molded body 6 obtained by a secondary injection molding process.

Compared to the current encapsulation molding method, the inductor device is formed through twice injection molding processes in this application, offering higher molding efficiency. Additionally, by utilizing twice injection molding processes, it becomes easier for the molding material to penetrate into smaller gaps, ensuring more adequate filling of the molding material at the corners. This also helps to reduce the injection pressure, decrease the impact force on the magnetic core 2, and lower the risk of cracking or damage to the magnetic core 2. The primary injection-molded body 3 formed during the primary injection molding process can serve as a positioning reference for the secondary injection molding process, making it easier to ensure the positional accuracy of various components in the inductor device.

To further enhance the stability of the process, in some embodiments, the injection pressure for the secondary injection molding process is set higher than that for the primary injection molding process. After securing the coil 1 and the magnetic core 2 by means of the primary injection molding process, these components, protected by the primary injection-molded body 3, can withstand greater injection pressures. Therefore, when the injection pressure for the secondary injection molding process is higher than that for the primary injection molding process, it not only completes the secondary injection molding process for the inductor device but also reduces the pressure for the primary injection molding process, thereby providing better protection for the magnetic core 2. In some other embodiments, the injection pressure for the secondary injection molding process may also be equal to that for the primary injection molding process. Of course, when the strength of the magnetic core 2 meets the requirements, the injection pressure for the secondary injection molding process may be lower than that for the primary injection molding process.

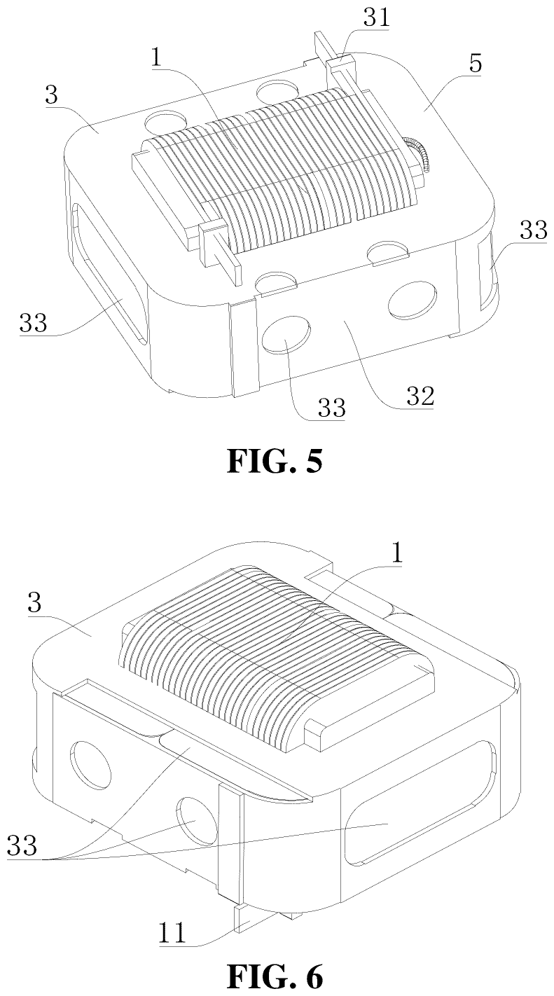

To facilitate the secondary injection molding process, further, in some embodiments, as shown in FIG. 5, during the primary injection molding process, a lead-out fixing part 31 is injection-molded onto the lead-out terminal 11 of the coil 1, fixing the lead-out terminal 11 in place. After the lead-out terminal 11 is fixed by the primary injection-molded body 3, it becomes less prone to wobbling, eliminating the need for a special positioning mold during the secondary injection molding process. This simplifies the process flow of the secondary injection molding process and enhances the molding efficiency.

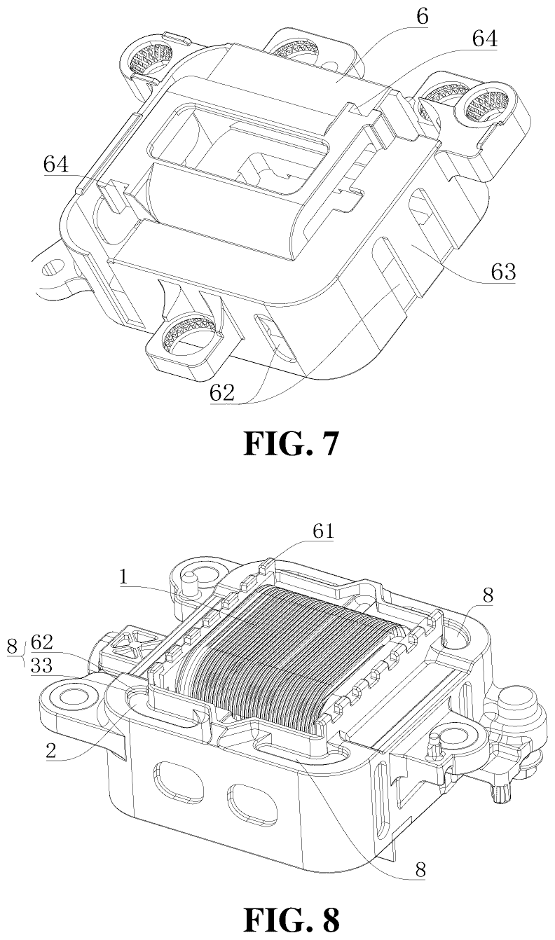

Further, to enhance the fixing strength of the lead-out terminal 11, in some embodiments, as shown in FIGS. 1 and 7, during the secondary injection molding process, a portion of the secondary injection-molded body 6 is injected onto the lead-out fixing part 31 for reinforcement. By reinforcing the lead-out terminal 11 with the secondary injection-molded body 6, the stability of the lead-out terminal 11 is improved.

Specifically, as shown in FIGS. 1, 5 and 7, the lead-out fixing part 31 is arranged protruding from the primary injection-molded body 3 and is injection-molded in a strip shape onto the lead-out terminal 11. After the secondary injection-molded body 6 is injection-molded, it partially surrounds the lead-out fixing part 31. That is, the secondary injection-molded body 6 forms a fixing slot 64, and the lead-out fixing part 31 is arranged within the fixing slot 64.

In some other embodiments, the lead-out terminal 11 may also be fixed by the secondary injection-molded body 6 during the secondary injection molding process.

In some embodiments, as shown in FIGS. 1 and 2, after the primary injection-molded body 3 and the secondary injection-molded body 6 of the inductor device are injection-molded, an insert 4 is fixed within the secondary injection-molded body 6. In some embodiments, the insert 4 may include a fixing nut 41 for securing the inductor and a terminal nut 42 for wire connection. In some other embodiments, the insert 4 may be configured as needed, such as including only the fixing nut or only the terminal nut. Of course, the insert may also utilize other types of components, such as support pieces, sensors, etc.

In some embodiments, as shown in FIG. 1, the inductor device may include a conducting bar 7, which is fixed to the lead-out terminal 11 of the coil 1. Specifically, the conducting bar 7 may be connected through any feasible conductive connection method, such as welding, adhesion, or connection with fasteners.

In some embodiments, as shown in FIGS. 1 and 2, the conducting bar 7 is attached to the surface of the secondary injection-molded body 6, with one end fixed to the lead-out terminal 11 and the other end, after wiring, fixed to the terminal nut 42. This allows the fixing of the conducting bar 7 to be more stable, reducing the likelihood of loosening due to external forces.

In some embodiments, the inductor device may be a high-power inductor applied in scenarios such as automobiles. Since high-power inductors require heat dissipation, considerations must be given to the issue of heat dissipation.

In some embodiments, as shown in FIGS. 1 and 2, to enhance the heat dissipation capability of the inductor, after the inductor device is formed, both sides of the coil 1 are exposed, allowing for heat dissipation or contact with a thermal pad to conduct heat to the thermal pad.

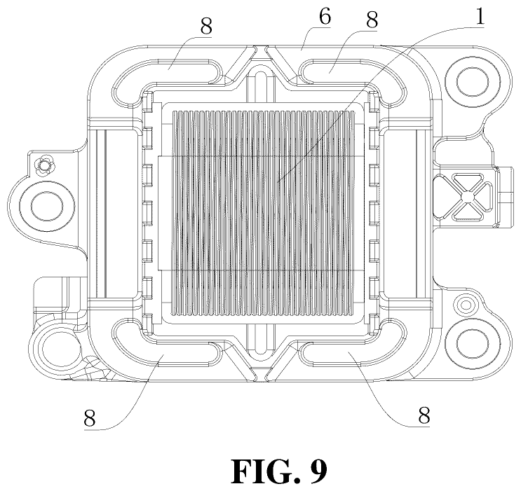

To further improve the heat dissipation performance of the inductor device, in some embodiments, as shown in FIGS. 8 and 9, during the primary injection molding process, a primary injection positioning mold is used to contact and position the magnetic core 2, and forms a primary process hole 33 during the primary injection molding process. During the secondary injection molding process, at least a secondary injection positioning mold may be inserted into the primary process hole 33 to position the primary molded body 5, and may form a secondary process hole 62 during the secondary injection molding. The at least a secondary process hole 62 may be communicated with the primary process hole 33 to form a through-hole 8. In this way, the through-hole 8 allows the magnetic core 2 to directly dissipate heat externally, improving the heat dissipation efficiency of the inductor device.

In some embodiments, as shown in FIGS. 5 to 7, there may be a plurality of primary process holes 33, with each side of the primary molded body 5 being provided with the primary process hole 33. Some of the primary process holes 33 may also be arranged at the corners of the primary molded body 5. Similarly, there may also be a plurality of secondary process holes 62.

The present disclosure also provides an inductor device that can be manufactured using the aforementioned forming method. The following is a detailed introduction to the inductor device.

As shown in FIGS. 1 to 7, the inductor device may include a coil 1, a magnetic core 2, a primary injection-molded body 3 and a secondary injection-molded body 6; the primary injection-molded body 3 fixes the coil 1 and the magnetic core 2, and at least a portion of the primary injection-molded body 3 fills the gap between the coil 1 and the magnetic core 2. The inductor device may also include an insert 4; and the secondary injection-molded body 6 is formed on the primary injection-molded body 3 and fixes the insert 4.

Further, in some embodiments, the inductor device may be a high-power inductor applied in scenarios such as automobiles. Due to the heat dissipation requirements of high-power inductors, considerations must be given to the issue of heat dissipation. As shown in FIGS. 1 and 2, the coil 1 may have exposed first and second heat dissipation surfaces 12 and 13, which are arranged opposite to each other. The first and second heat dissipation surfaces 12 and 13 can dissipate heat externally, thereby improving the heat dissipation efficiency of the inductor. In some other embodiments, the coil 1 may only have the first heat dissipation surface 12, while the second heat dissipation surface 13 may be covered by the secondary injection-molded body 6.

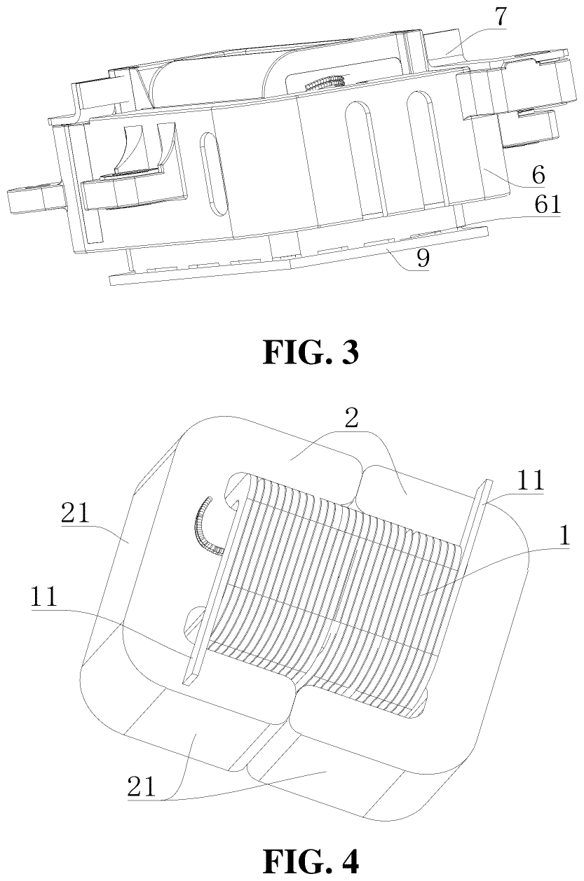

In some embodiments, as shown in FIGS. 2 and 3, the secondary injection-molded body 6 may have a thermal pad positioning tooth 61 that can press against the thermal pad 9 that adheres to the first heat dissipation surface 12. In a direction perpendicular to the first heat dissipation surface 12, the top surface of the thermal pad positioning tooth 61 may be lower than the plane in which the first heat dissipation surface 12 is situated. This ensures that the thermal pad positioning tooth 61 do not interfere with the contact between the thermal pad and the first heat dissipation surface 12. In some other embodiments, the top surfaces of the thermal pad positioning tooth 61 may also be level with the plane of the first heat dissipation surface 12.

Specifically, as shown in FIGS. 2 and 3, the inductor device may adopt water cooling for heat dissipation; and in this respect, the thermal pad 9 is used to transfer heat between the inductor device and a water-cooling plate. The heat generated by the inductor device is transferred to the water-cooling plate through the thermal pad 9. When the existing inductor device is applied in vibrating environments, the thermal pad 9 currently is prone to shifting relative to the inductor device, and after a long period of time, it may easily separate from the inductor device, leading to the reduction of the heat transfer efficiency. To address it, the thermal pad positioning tooth 61 is used to press against the thermal pad 9, creating indentations on it; and in this way, the thermal pad 9 is less likely to move relative to the inductor device, thus enhancing the stability of heat dissipation of the inductor device.

Specifically, there may be a plurality of the thermal pad positioning teeth 61 arranged circumferentially along the first heat dissipation surface 12.

In some embodiments, as shown in FIGS. 1, 5 and 7, the coil 1 may be equipped with the lead-out terminal 11, the primary injection-molded body 3 may include the lead-out fixing part 31 that is injection-molded onto the lead-out terminal 11 and secures the lead-out terminal 11, and a part of the secondary injection-molded body 6 is injection-molded onto the lead-out fixing part 31 for reinforcement. By reinforcing the lead-out terminal 11 with the secondary injection-molded body 6, the stability of the lead-out terminal 11 can be improved.

Specifically, as shown in FIGS. 1, 5 and 7, the lead-out fixing part 31 is arranged protruding from the primary injection-molded body 3 and is injection-molded in a strip shape onto the lead-out terminal 11. After the secondary injection-molded body 6 is injection-molded, it partially encircles the lead-out fixing part 31. That is, the secondary injection-molded body 6 forms the fixing slot 64, and the lead-out fixing part 31 is positioned within the fixing slot 64.

In some other embodiments, the lead-out terminal 11 may also be fixed by the secondary injection-molded body 6 during the secondary injection molding process.

In some embodiments, as shown in FIGS. 8 and 9, the primary injection-molded body 3 may have a primary process hole 33 that allow the primary injection positioning mold to contact and position the magnetic core 2. The coil 1, the magnetic core 2 and the primary injection-molded body 3 may form the primary molded body 5. The secondary injection-molded body 6 may have the secondary process hole 62 that allow a secondary injection positioning mold to contact and position the primary molded body 5. At least a secondary process hole 62 may be communicated with the primary process hole 33 to form the through-hole 8. In this way, the through-hole 8 can allow the magnetic core 2 to directly dissipate heat externally, thereby improving the heat dissipation efficiency of the inductor device. In some other embodiments, the primary process hole 33 and the secondary process hole 62 may not be communicated, and in this respect, heat dissipation through the process holes is not required.

In some embodiments, as shown in FIGS. 5 to 7, there may be a plurality of primary process holes 33, with each side of the primary molded body 5 being provided with the primary process hole 33. Some of the primary process holes 33 may also be arranged at the corners of the primary molded body 5. Similarly, there may also be a plurality of secondary process holes 62.

Specifically, in some embodiments, as shown in FIGS. 8 and 9, the through-hole 8 and the thermal pad positioning tooth 61 are arranged on the same side of the secondary injection-molded body 6. This arrangement allows a portion of the heat dissipated by the through-hole 8 to be taken away by a heat sink that is in contact with the thermal pad.

In some embodiments, as shown in FIGS. 1 and 5, the primary injection-molded body 3 may include a primary injection-molded layer 32 that covers the side of the magnetic core 2 opposite to the coil 1, the secondary injection-molded body 6 may include a secondary injection-molded layer 63 arranged on the outer side of the primary injection-molded layer 32. The ratio of the thickness of the secondary injection-molded layer 63 to the thickness of the primary injection-molded layer 32 may be greater than 1. This design ensures that the primary injection-molded body 3 has a smaller thickness, resulting in lower primary injection pressure, which reduces the risk of damaging the magnetic core 2 during molding.

Specifically, in some embodiments, the thickness of the secondary injection-molded layer 63 and the thickness of the primary injection-molded layer 32 may be determined according to the size of the inductor device.

It should be understood that in some embodiments, as shown in FIG. 4, the coil 1 is displaced within the space enclosed by the magnetic core 2, and the side of the magnetic core 2 opposite to the coil 1 refers to the outer circumferential surface 21 of the magnetic core 2. As shown in FIGS. 1, 5 and 7, the thickness of the primary injection-molded layer 32 and the thickness of the secondary injection-molded layer 63 are defined relative to the layered positions of the primary injection-molded body 3 and the secondary injection-molded body 6; and the positions where the primary injection-molded body 3 and the secondary injection-molded body 6 are not layered do not fall within the scope of the molded layers. For example, regarding the primary injection-molded body 3, the part between the magnetic core 2 and the coil 1 does not belong to the primary injection-molded layer 32; and regarding the secondary injection-molded body 6, the location of the insert 4 and the part within the primary process hole 33 do not belong to the secondary injection-molded layer 63.

In some other embodiments, under certain circumstances, the ratio of the thickness of the primary injection-molded layer 32 to the thickness of the secondary injection-molded layer 63 may also be equal to 1 or greater than 1.

The specific examples provided above are used to illustrate the present disclosure solely for the purpose of facilitating understanding and are not intended to limit the scope of the present disclosure. For those skilled in the art, several simple deductions, modifications or substitutions to the aforementioned specific embodiments can be made based on the principles of this present application.

What is claimed is:

1. A forming method for an inductor device, comprising:
securing a coil and a magnetic core together by means of a primary injection-molded body obtained by a primary injection molding process, so that the coil, the magnetic core and the primary injection-molded body form a primary molded body, and subsequently, fixing an insert in the inductor device and the primary molded body together by means of a secondary injection-molded body obtained by a secondary injection molding process;
wherein, the insert includes a fixing nut for fixing the inductor device and a terminal nut for wire connection;
wherein, during the primary injection molding process, a lead-out fixing part is injection-molded onto a lead-out terminal of the coil for securing the lead-out terminal in place; and during the secondary injection molding process, a part of the secondary injection-molded body is injection-molded onto the lead-out fixing part for reinforcement; and
securing a conducting bar of the inductor device to the lead-out terminal.

2. The forming method for an inductor device according to claim 1, wherein an injection pressure for the secondary injection molding process is greater than an injection pressure for the primary injection molding process.

3. The forming method for an inductor device according to claim 1, wherein during the primary injection molding process, the magnetic core is contacted and positioned by a primary injection positioning mold that forms a primary process hole during the primary injection molding process; and
during the secondary injection molding process, at least a secondary injection positioning mold that forms a secondary process hole during the secondary injection molding process is inserted into the primary process hole to position the primary molded body, wherein at least one secondary process hole form a through-hole with the primary process hole.

4. The forming method for an inductor device according to claim 3, wherein an injection pressure for the secondary injection molding process is greater than an injection pressure for the primary injection molding process.

5. An inductor device obtained by the forming method for an inductor device according to claim 1, comprising a coil, a magnetic core, a primary injection-molded body and a secondary injection-molded body, the primary injection-molded body securing the coil and the magnetic core, and at least a part of the primary injection-molded body being arranged in a gap between the coil and the magnetic core;
the inductor device further comprising an insert, the secondary injection-molded body being formed on the primary injection-molded body to fix the insert, and the insert including a fixing nut for securing the inductor device and a terminal nut for wire connection;
the coil comprising a lead-out terminal, the primary injection-molded body comprising a lead-out fixing part that is injection-molded on the lead-out terminal and secures the lead-out terminal, a part of the secondary injection-molded body being injection-molded on the lead-out fixing part for reinforcement; and
the inductor device further comprising a conducting bar that is secured with the lead-out terminal.

6. The inductor device according to claim 5, wherein the coil has an exposed first heat dissipation surface, the secondary injection-molded body has a thermal pad positioning tooth configured to press against a thermal pad attached onto the first heat dissipation surface, and, in a direction perpendicular to the first heat dissipation surface, a top surface of the thermal pad positioning tooth is level with or lower than a plane of the first heat dissipation surface.

7. The inductor device according to claim 5, wherein the primary injection-molded body has a primary process hole configured to allow a primary injection positioning mold to contact and position the magnetic core, wherein the coil, the magnetic core and the primary injection-molded body together form a primary molded body; the secondary injection-molded body has a secondary process hole configured to allow a secondary injection positioning mold to contact and position the primary molded body; and at least a secondary process hole and the primary process hole are communicated to form a through-hole.

8. The inductor device according to claim 7, wherein the coil has an exposed first heat dissipation surface, the secondary injection-molded body has a thermal pad positioning tooth configured to press against a thermal pad attached onto the first heat dissipation surface, and, in a direction perpendicular to the first heat dissipation surface, a top surface of the thermal pad positioning tooth is level with or lower than a plane of the first heat dissipation surface.

9. The inductor device according to claim 5, wherein the primary injection-molded body comprises a primary injection-molded layer covering a side of the magnetic core that faces away from the coil, and the secondary injection-molded body comprises a secondary injection-molded layer arranged at an outer side of the primary injection-molded layer, wherein a ratio of a thickness of the secondary injection-molded layer to a thickness of the primary injection-molded layer is greater than 1.

10. The inductor device according to claim 9, wherein the coil has an exposed first heat dissipation surface, the secondary injection-molded body has a thermal pad positioning tooth configured to press against a thermal pad attached onto the first heat dissipation surface, and, in a direction perpendicular to the first heat dissipation surface, a top surface of the thermal pad positioning tooth is level with or lower than a plane of the first heat dissipation surface.
